(19) United States
(12) Patent Application Publication
(10) Pub. No.: US 2017/0118451 A1
(43) Pub. Date: Apr. 27, 2017

(54) INFORMATION PROCESSING APPARATUS, IMAGE PROJECTION SYSTEM, AND COMPUTER PROGRAM PRODUCT

(71) Applicant: Daisuke SAKAI, Tokyo (JP)

(72) Inventor: Daisuke SAKAI, Tokyo (JP)

(21) Appl. No.: 15/294,017

(22) Filed: Oct. 14, 2016

(30) Foreign Application Priority Data
Oct. 26, 2015 (JP) 2015-209561

(51) Int. Cl. H04N 9/31

(52) U.S. Cl. CPC H04N 9/3185; H04N 9/3147

(57) ABSTRACT

An information processing apparatus includes a calibration-image extractor, an identification-information extractor, a locator, a calculator, and a corrector. The calibration-image extractor is configured to extract calibration images from a captured image that includes calibration images projected by image projection apparatuses. Each calibration image includes a calibration pattern embedded with identification information of a corresponding image projection apparatus. The identification-information extractor is configured to extract the identification information from the calibration images. The locator is configured to identify the image projection apparatuses and locate projection positions based on the identification information and positions of the calibration images. The calculator is configured to calculate calibration parameters of the image projection apparatuses based on the calibration images. The corrector is configured to split a content image into split images and correct the split images based on the number of, the projection positions of, and the calibration parameters of the image projection apparatuses.

### CROSS-REFERENCE TO RELATED APPLICATION

The present application claims priority under 35 U.S.C. §119 to Japanese Patent Application No. 2015-209561, filed Oct. 26, 2015. The contents of which are incorporated herein by reference in their entirety.

### BACKGROUND OF THE INVENTION

1. Field of the Invention

The present invention relates generally to an information processing apparatus, an image projection system, and a computer program product.

2. Description of the Related Art

Multi-image projection is a conventional technique for providing a large screen by causing split images, into which a content image is split, to be projected from a plurality of projectors.

Correcting the split images in advance is typically necessary to make a screen image, into which images projected by the plurality of projectors are joined, appear to be free from warping. Therefore, in multi-image projection, it is typically required to cause a calibration pattern to be projected from each of the plurality of projectors and analyze an image obtained by image capture of the calibration patterns, thereby calculating calibration parameters for use in the correction.

Accordingly, conventional multi-image projection techniques disadvantageously require an image capture job be performed at least twice to detect positions of projectors and to calculate calibration parameters.

### SUMMARY OF THE INVENTION

According to one aspect of the present invention, an information processing apparatus includes a captured-image receiver, a calibration-image extractor, an identification-information extractor, a projection-position locator, a calibration-parameter calculator, and an image corrector. The captured-image receiver is configured to receive a captured image that includes projected images of calibration images projected by a plurality of image projection apparatuses. Each calibration image includes a calibration pattern in which identification information of a corresponding image projection apparatus is embedded. The calibration-image extractor is configured to extract the calibration images from the captured image. The identification-information extractor is configured to extract the identification information from the extracted calibration images. The projection-position locator is configured to identify the image projection apparatuses having projected the calibration images and locate projection positions of the image projection apparatuses based on the identification information extracted from the calibration images and positions of the calibration images in the captured image. The calibration-parameter calculator is configured to calculate calibration parameters of the respective image projection apparatuses having projected the calibration images, based on the extracted calibration images. The image corrector is configured to split a content image into a plurality of split images and correct the split images based on the number of the identified image projection apparatuses, the projection positions of the image projection apparatuses, and the calibration parameters of the image projection apparatuses.

### BRIEF DESCRIPTION OF THE DRAWINGS

FIG. 1 is a system configuration diagram of an image projection system of an embodiment;

FIG. 2 is a functional block diagram of the image projection system of the embodiment;

FIG. 3 is a flowchart illustrating processing executed by an image projection apparatus of the embodiment;

FIG. 4 illustrates a calibration image;

FIG. 5 is a diagram illustrating a situation where calibration images are projected;

FIG. 6 is a flowchart illustrating processing executed by an information processing apparatus of the embodiment;

FIG. 7 illustrates processing executed by the information processing apparatus of the embodiment;

FIG. 8 illustrates a device-information management table;

FIG. 9 illustrates processing executed by the information processing apparatus of the embodiment;

FIG. 10 is a diagram illustrating a situation where a content image is projected; and

FIGS. 11A and 11B are hardware configuration diagrams of the image projection system of the embodiment.

The accompanying drawings are intended to depict exemplary embodiments of the present invention and should not be interpreted to limit the scope thereof. Identical or similar reference numerals designate identical or similar components throughout the various drawings.

### DESCRIPTION OF THE EMBODIMENTS

The terminology used herein is for the purpose of describing particular embodiments only and is not intended to be limiting of the present invention.

As used herein, the singular forms “a”, “an” and “the” are intended to include the plural forms as well, unless the context clearly indicates otherwise.

In describing preferred embodiments illustrated in the drawings, specific terminology may be employed for the sake of clarity. However, the disclosure of this patent specification is not intended to be limited to the specific terminology so selected, and it is to be understood that each specific element includes all technical equivalents that have the same function, operate in a similar manner, and achieve a similar result.

Exemplary embodiments of the present invention are described below. It should be understood that the embodiments described below are not intended to limit the scope of the present invention. Elements common between the drawings referred to in the description may retain the same numerical designation, and repeated description of the elements is omitted as appropriate.

An object of an embodiment is to provide an image projection apparatus, an image projection system, and a computer program product capable of detecting positions of projectors and calculating calibration parameters of the projectors by performing image capture a single time.

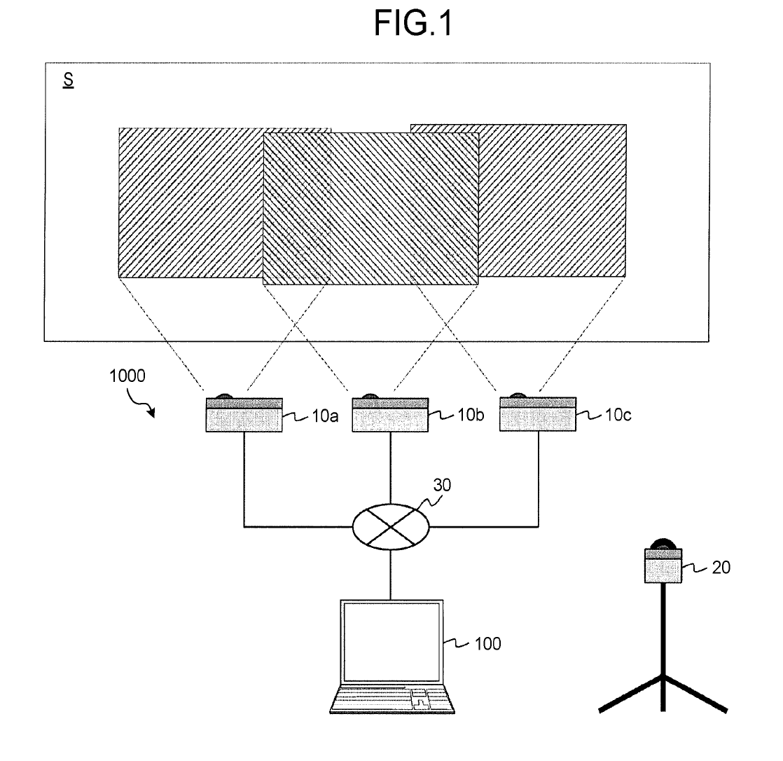

FIG. 1 is a system configuration diagram of an image projection system 1000 according to an embodiment of the present invention. The image projection system 1000 is a system for performing multi-image projection that provides a large screen by joining images projected by a plurality of projectors. The image projection system 1000 of the embodiment includes a plurality of projectors 10 and an information processing apparatus 100 that controls multi-image projection. The plurality of projectors 10 (10a, 10b, and 10c) and the information processing apparatus 100 are mutually-communicably connected via a network 30. The network 30, which is, for example, a LAN (Local Area Network) or a PAN (Personal Area Network), may be either wired or wireless.

The projector 10 is an image projection apparatus that projects an image onto a projection surface, such as a screen. To perform multi-image projection, it is typically necessary to cause a sender, from which the images are transmitted to the projectors, to be aware of locations of the projectors so that the split content images are allocated to the projectors correctly. Referring to the example illustrated in FIG. 1, the three projectors (10a, 10b, and 10c) are arranged side by side along a widthwise direction of a projection surface S. Each adjacent two of the projectors 10 are positioned such that their projection areas partially overlap. The layout illustrated in FIG. 1, in which the three projectors 10 are arranged side by side, is given for the sake of example only. The projectors 10, the number of which can be any number (greater than one), can be arranged in any desired layout. The description below is given through the example, in which the three projectors 10 are arranged side by side.

The information processing apparatus 100 is an information processing apparatus for transmitting an image to and causes the image to be projected by each of the projectors 10a, 10b, and 10c. The information processing apparatus 100 can be, for example, a personal computer (PC). While FIG. 1 illustrates a notebook PC as the information processing apparatus 100, alternatively, the information processing apparatus 100 may be a desktop PC or, further alternatively, a tablet PC, a smartphone, or the like. Hereinafter, the information processing apparatus 100 is referred to as “the PC 100”.

In a preferred embodiment, the image projection system 1000 further includes a camera 20. The camera 20 is an image capture device for capturing projected images projected by the plurality of projectors 10. The camera 20 is a digital camera including a CCD (charge-coupled device) image sensor or a CMOS (complementary metal oxide semiconductor) digital image sensor as an imaging device. While FIG. 1 illustrates the camera 20 as a discrete device, alternatively, a digital camera included in the PC 100 may be used as the camera 20.

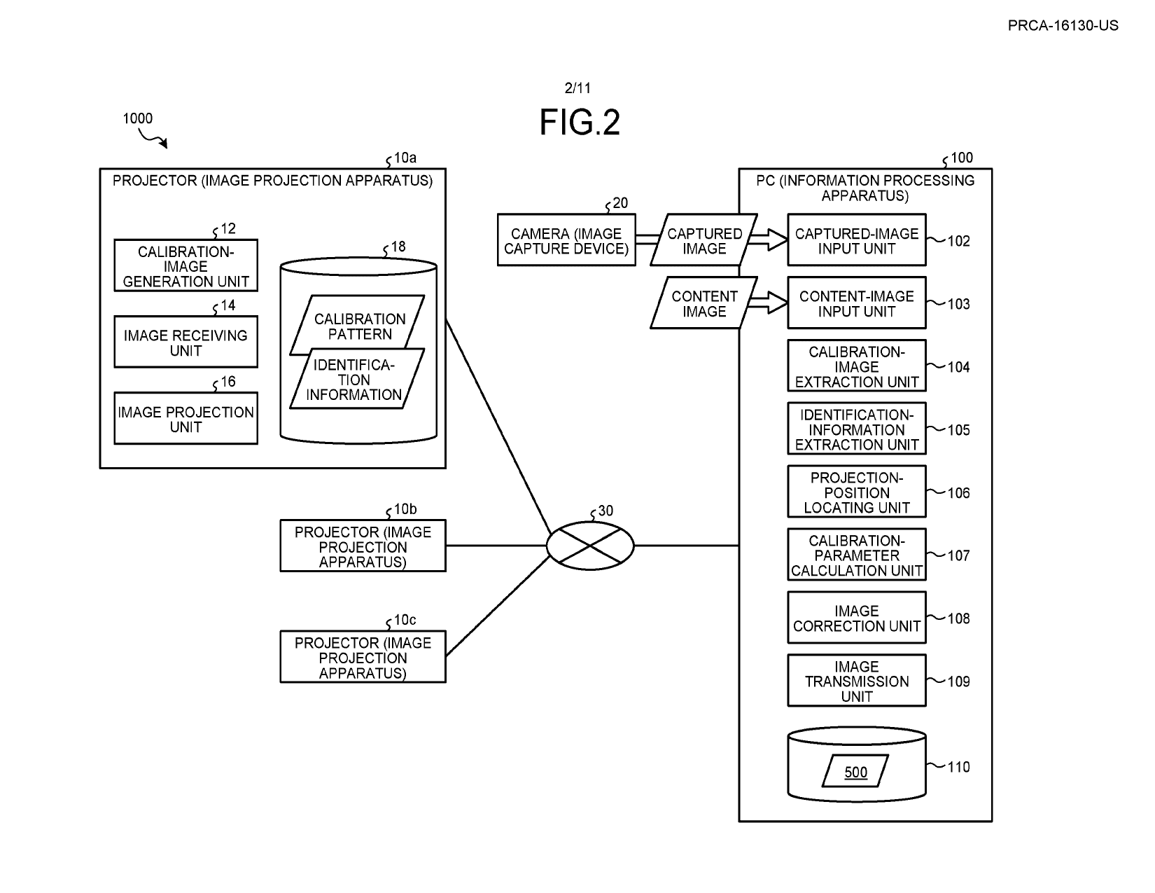

The system configuration of the image projection system 1000 of the embodiment has been described above. A functional configuration of the projectors 10 and the PC 100 is described below with reference to the functional block diagram illustrated in FIG. 2.

The projector 10 includes a calibration-image generation unit 12, an image receiving unit 14, and an image projection unit 16.

The calibration-image generation unit 12 is a functional unit for generating a calibration image by embedding identification information about the apparatus (the projector 10), to which the calibration-image generation unit 12 belongs, in a calibration pattern (which will be described later).

The image receiving unit 14 is a functional unit for receiving an image from the PC 100 via the network 30.

The image projection unit 16 is a functional unit for controlling image projection. The image projection unit 16 projects the calibration image generated by the calibration-image generation unit 12 onto a projection surface and also projects the image received by the image receiving unit 14 from the PC 100 onto the projection surface.

The PC 100 includes a captured-image input unit (captured-image receiver) 102, a content-image input unit (content-image receiver) 103, a calibration-image extraction unit 104, an identification-information extraction unit 105, a projection-position locating unit 106, a calibration-parameter calculation unit 107, an image correction unit 108, and an image transmission unit 109.

The captured-image input unit 102 is a functional unit for receiving a captured image, in which projected images of the calibration images projected simultaneously by the plurality of projectors 10 are collectively captured.

The content-image input unit 103 is a functional unit for receiving a source content image to be projected onto the projection surface to form a large-screen image.

The calibration-image extraction unit 104 is a functional unit for extracting the calibration images from the captured image.

The identification-information extraction unit 105 is a functional unit for extracting the identification information about the projectors 10 from the extracted calibration images.

The projection-position locating unit 106 is a functional unit for identifying the projectors 10 that have projected the calibration images and locating their projection positions.

The calibration-parameter calculation unit 107 is a functional unit for calculating calibration parameters of the respective projectors 10 from the plurality of extracted calibration images.

The image correction unit 108 is a functional unit for splitting the content image into a plurality of split images and correcting each of the split images based on the calculated calibration parameter.

The image transmission unit 109 is a functional unit for transmitting each of the corrected split images to a corresponding one of the projectors 10.

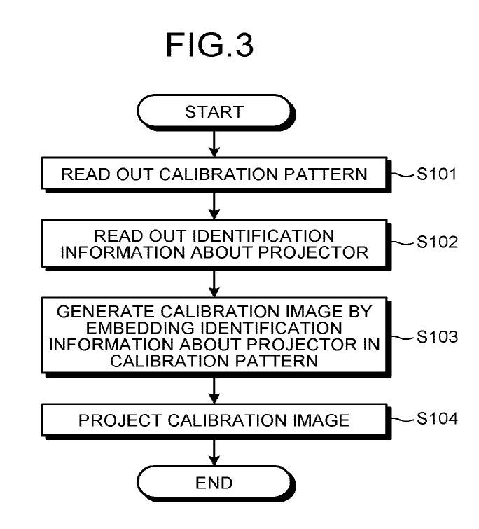

The functional configuration of the projector 10 and the PC 100 has been described above. Processing executed first to perform multi-image projection using the image projection system 1000 by each of the projectors 10 is described below with reference to the flowchart illustrated in FIG. 3. The description below is made with reference to FIG. 2 as appropriate.

The projector 10 of the embodiment starts processing illustrated in FIG. 3 in response to a power-on operation or an appropriate operation performed by a user.

At step S101, the calibration-image generation unit 12 reads out a calibration pattern from a predetermined storage area 18.

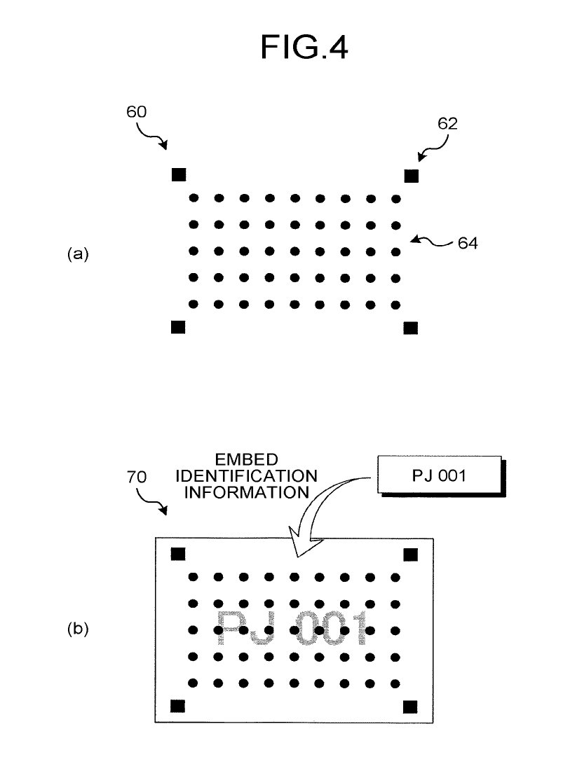

In FIG. 4, (a) illustrates a calibration pattern 60, which is an example of the calibration pattern used in the embodiment. As illustrated in (a) in FIG. 4, the calibration pattern 60 is made up of four corner patterns (denoted by 62) and a dot pattern 64 arranged in a rectangular region defined by the corner patterns 62 that lie on vertexes of the rectangular region. The corner patterns 62 are patterns for defining the four corners of the calibration pattern. The dot pattern 64 is a pattern for detecting trapezoidal distortion, local distortion, and the like of a projected image. The calibration pattern 60 illustrated in (a) in FIG. 4 is for the sake of example only, and applicable calibration patterns are not limited thereto.

Thereafter, the calibration-image generation unit 12 reads identification information about the projector 10 from the predetermined storage area 18 (step S102), and generates a calibration image by embedding the identification information in the calibration pattern read out at step S101 (step S103).

In FIG. 4, (b) conceptually illustrates how a calibration image 70 (70a, 70b, 70c) is generated by embedding the identification information about the projector 10 in the calibration pattern illustrated in (a) in FIG. 4. In FIG. 4, (b) illustrates an example, in which a device ID “PJ001” is embedded as the identification information about the projector 10. For the sake of understanding, graphic characters of a character string “PJ001” are displayed in a superimposed manner in (b) in FIG. 4. However, in practice, in the embodiment, a character code corresponding to the character string “PJ001” is embedded in the calibration pattern 60 by dedicated application program instructions as “digital watermark” in a fashion unperceivable to human eyes. The “digital watermark” in the embodiment is a concept embracing all data embedded in a computer-understandable fashion; the identification information may be embedded in a fashion perceivable to human eyes so long as the embedded information does not impede detection of the calibration pattern.

Lastly, the image projection unit 16 projects the calibration image generated at step S103 onto a projection surface (step S104). Then, processing ends.

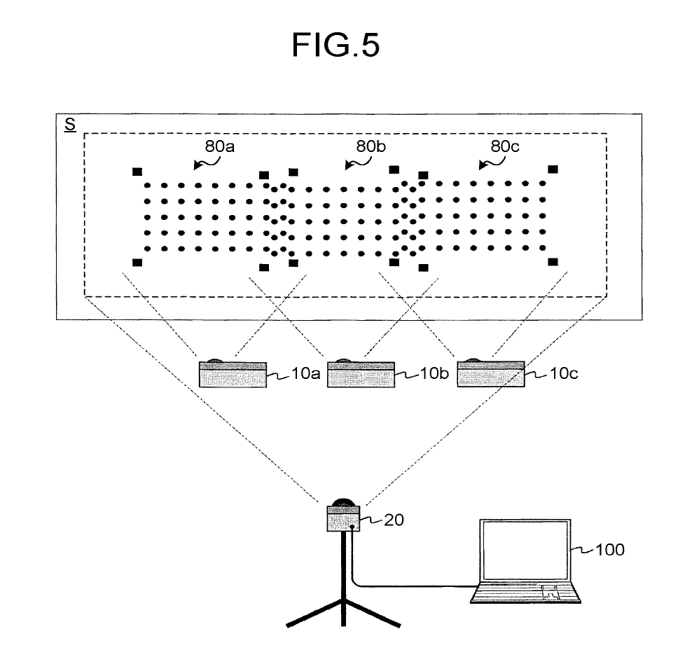

FIG. 5 illustrates a situation where the calibration images obtained by the three projectors (10a, 10b, and 10c) included in the image projection system 1000 by executing the series of processes illustrated in FIG. 3 are projected from the projectors 10 simultaneously. As illustrated in FIG. 5, a projected image 80a of the calibration image 70a projected by the projector 10a, a projected image 80b of the calibration image 70b projected by the projector 10b, and a projected image 80c of the calibration image 70c projected by the projector 10c are arranged side by side along the widthwise direction of the projection surface S. Each adjacent two (the projected image 80a and the projected image 80b, the projected image 80b and the projected image 80c) of the projected images partially overlap.

In the embodiment, at this point, a user performs image capture of the projection surface S using the camera 20 such that the three projected images 80 (80a, 70b, and 70c) are collectively captured in a single image. Thereafter, the thus-captured image obtained by the camera 20 is provided to the PC 100 by an appropriate method. The captured-image input unit 102 of the PC 100 receives an input of the captured image provided by the camera 20 and stores the captured image in a storage area 110. While FIG. 5 illustrates an example where the captured image obtained by the camera 20 is transferred to the PC 100 by wired communication, the captured image may alternatively be wirelessly transferred from the camera 20 to the PC 100. Further alternatively, the captured image may be moved from the camera 20 to the PC 100 via a recording medium, such as a USB (universal serial bus) memory and an SD (secure digital) memory.

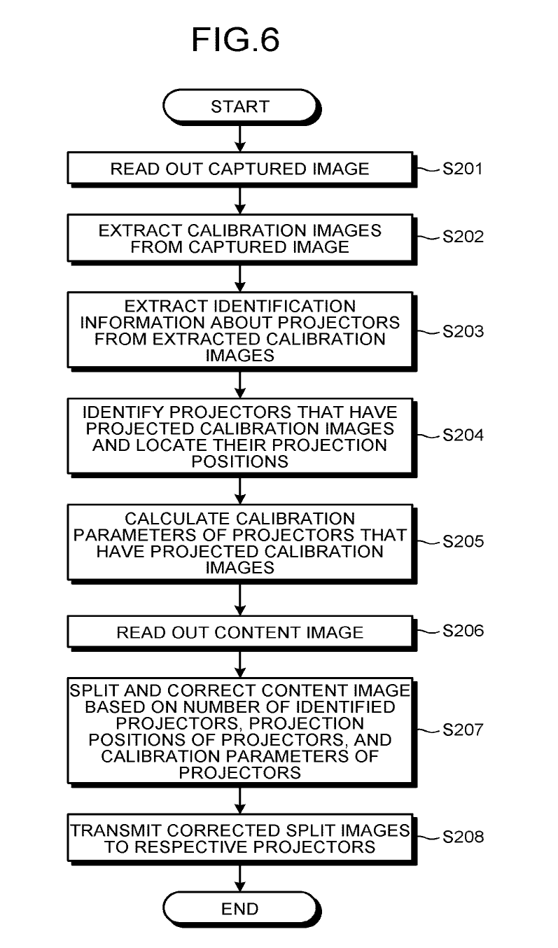

Processing executed by the PC 100 when image capture with the camera 20 is completed is described below with reference to the flowchart illustrated in FIG. 6. The description below is made with reference to FIG. 2 as appropriate.

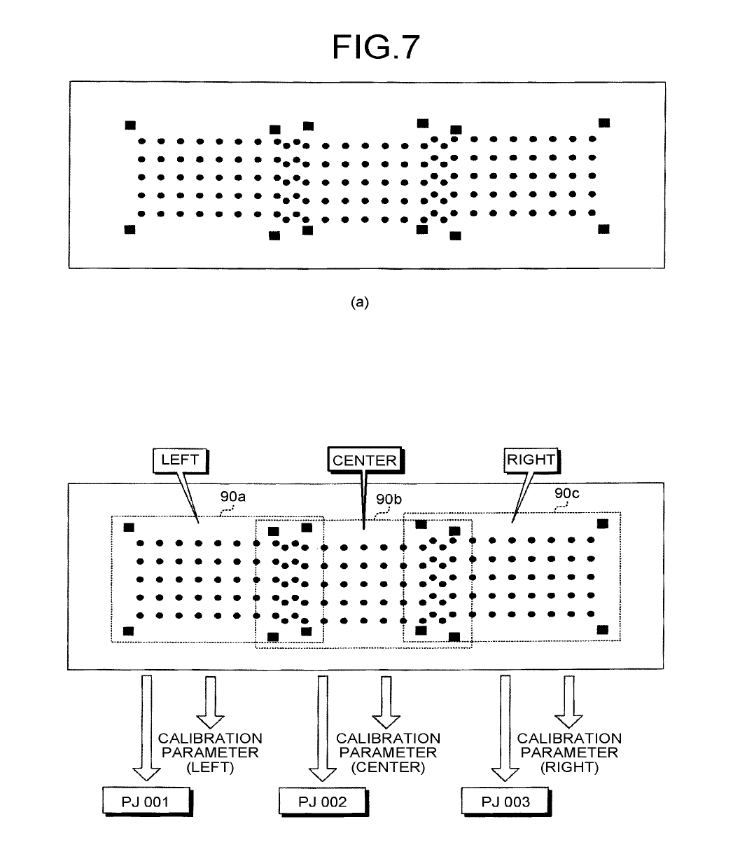

At step S201, the calibration-image extraction unit 104 reads out the captured image (the captured image in which the three projected images (80a, 80b, and 80c) are collectively captured) from the storage area 110. In FIG. 7, (a) illustrates the captured image read out at step S201.

At the next step, S202, the calibration-image extraction unit 104 performs image analysis using a predetermined algorithm, thereby extracting image areas 90 (90a, 90b, and 90c), in which the projected images 80 of the calibration images 70 are captured, from the captured image illustrated in (a) in FIG. 7. Hereinafter, the image areas 90 are simply referred to as “the calibration images 90”. For example, the calibration-image extraction unit 104 performs pattern matching by using the calibration pattern 60 (see (a) in FIG. 4) as a template, thereby extracting the calibration image 90a, the calibration image 90b, and the calibration image 90c as illustrated in (b) in FIG. 7 from the captured image illustrated in (a) in FIG. 7.

At the next step, S203, the identification-information extraction unit 105 extracts identification information about the projectors 10 embedded as digital watermark from the respective three calibration images (90a, 90b, and 90c) extracted at step S202. Specifically, the identification-information extraction unit 105 extracts the device ID “PJ001” of the projector 10a from the calibration image 90a, extracts a device ID “PJ002” of the projector 10b from the calibration image 90b, and extracts a device ID “PJ003” of the projector 10c from the calibration image 90c as illustrated in (b) in FIG. 7.

At the next step, S204, the projection-position locating unit 106 identifies each of the projectors 10 that has projected a corresponding one of the calibration images 90 and locates their projection positions. Specifically, the projection-position locating unit 106 identifies that the projector 10a associated with the identification information “PJ001” extracted from the calibration image 90a is the projection source of the calibration image 90a, and locates the projection position of the projector 10a as “left”, which is a position of the calibration image 90a in the captured image. Similarly, the projection-position locating unit 106 identifies that the projector 10b associated with the identification information “PJ002” extracted from the calibration image 90b is the projection source of the calibration image 90b, and locates the projection position of the projector 10b as “center”, which is a position of the calibration image 90b in the captured image. The projection-position locating unit 106 identifies that the projector 10c associated with the identification information “PJ003” extracted from the calibration image 90c is the projection source of the calibration image 90c, and locates the projection position of the projector 10c as “right”, which is a position of the calibration image 90c in the captured image.

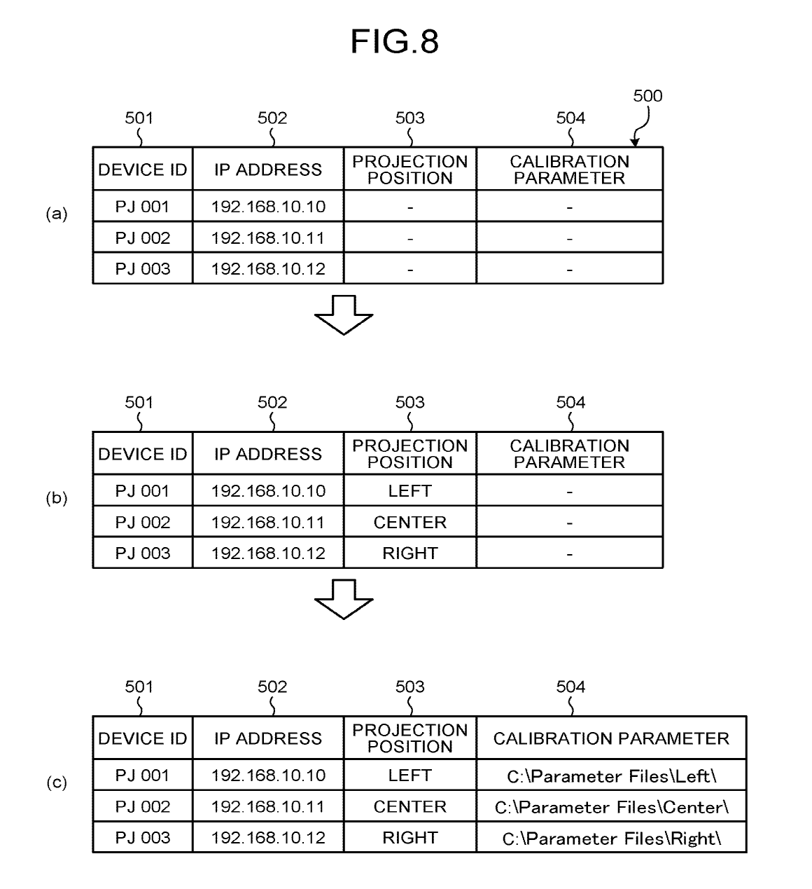

The projection-position locating unit 106 places the above-described identifying-and-locating result in a device-information management table 500 stored in the storage area 110. FIG. 8 illustrates the device-information management table 500. As illustrated in (a), (b), and (c) in FIG. 8, the device-information management table 500 contains a field 501 where the device IDs of the projectors 10 are to be placed, a field 502 where IP addresses, which are information about communication destinations of the projectors 10, are to be placed, a field 503 where projection positions of the projectors 10 are to be placed, and a field 504 where calibration parameters of the projectors 10 are to be placed.

Before the process at step S204 described above is performed, as illustrated in (a) in FIG. 8, the device-information management table 500 is in a state where values are placed only in the field 501 and the field 502, whereas the field 503 and the field 504 are left blank. At step S204, as illustrated in (b) in FIG. 8, the projection-position locating unit 106 places the located projection positions of the projectors 10 in the field 503 associated with the identification information (the device IDs) about the projectors 10 identified as the projection sources of the calibration images 90.

At the next step, S205, the calibration-parameter calculation unit 107 calculates calibration parameters of the projectors 10, which are the projection sources of the respective calibration images 90, based on the calibration patterns of the plurality of calibration images 90 extracted at step S202. Specifically, the calibration-parameter calculation unit 107 calculates a calibration parameter of the projector 10a, which is the projection source of the calibration image 90a, based on the calibration pattern contained in the calibration image 90a, calculates a calibration parameter of the projector 10b, which is the projection source of the calibration image 90b, based on the calibration pattern contained in the calibration image 90b, and calculates a calibration parameter of the projector 10c, which is the projection source of the calibration image 90c, based on the calibration pattern contained in the calibration image 90c. Because methods for calculating a calibration parameter for dewarping a projected image from a dot matrix of a calibration pattern are known, description of such a method is omitted.

As illustrated in (c) in FIG. 8, the calibration-parameter calculation unit 107 places the calibration parameters (specifically, locations where the calibration parameters are stored) of the projectors 10 calculated at step S205 in the field 504 associated with the identification information (the device IDs) about the projectors 10.

At the next step, S206, the image correction unit 108 reads out a content image, which is a source image to be projected onto the projection surface S to form a large-screen image, from the storage area 110. The content image to be projected may be fed from an auxiliary storage device of the PC 100 or via an interface for external inputs of the PC 100, received at the content-image input unit 103, and stored in the storage area 110.

At the next step, S207, the image correction unit 108 splits the content image read out at step S206 into split images of the same number as the projectors 10 and corrects each of the split images based on the number of the identified projectors 10, the projection positions of the respective projectors 10, and the calibration parameters of the respective projectors 10.

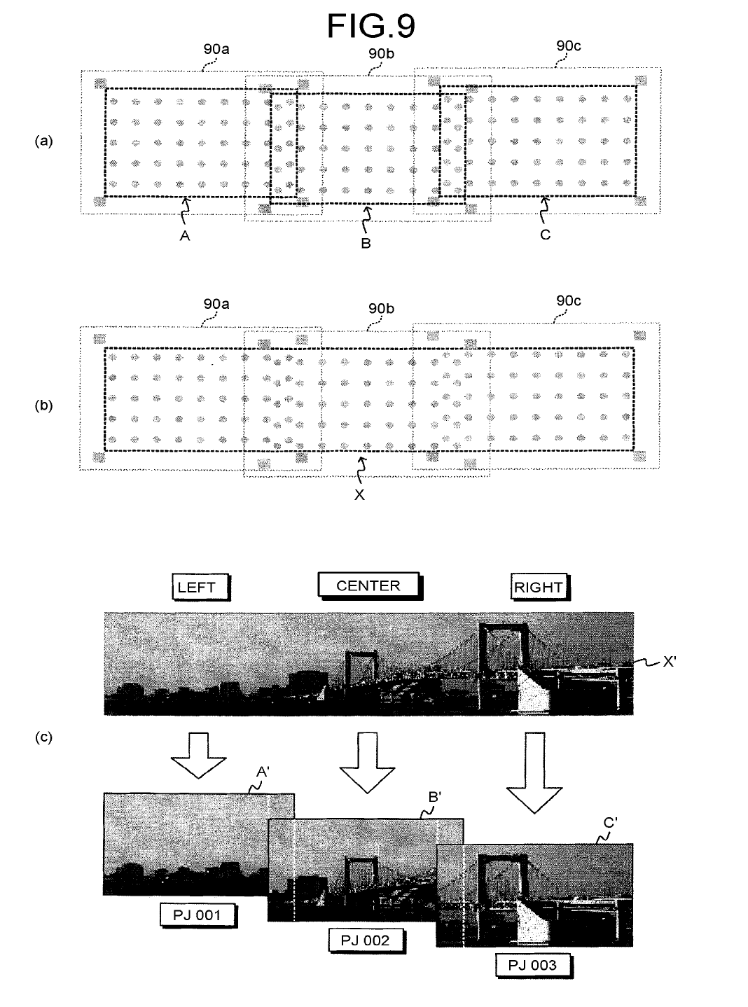

Specifically, first, the image correction unit 108 determines projection available areas A, B, and C of the projectors 10a, 10b, and 10c, which are the projection sources of the respective calibration images 90, as illustrated in (a) in FIG. 9 by linearly extrapolating the respective calibration patterns (dot patterns) of the three calibration images (90a, 90b, and 90c) that are captured in the captured image. Thereafter, the image correction unit 108 defines an OR of the determined projection available areas A, B, and C as a projection available area X of the entire system as illustrated in (b) in FIG. 9.

Next, the image correction unit 108 applies geometric correction to the content image so that the projection available area X contains the content image read out at step S206 in its maximum size with the aspect ratio of the content image maintained, and thereafter maps the corrected content image onto the projection available area X.

Next, as illustrated in (c) in FIG. 9, the image correction unit 108 splits a content image X′, which is the corrected content image mapped onto the projection available area X, into three split images (A′, B′, and C′) that fit the projection available areas A, B, and C of the projectors 10a, 10b, and 10c. Thereafter, the image correction unit 108 accesses the field 503 in the device-information management table 500 by keys, which are the relative positions (left, center, and right) of the split images, and allocates each of the split images to a corresponding one, in association with which a projection position (left, center, or right) that matches the key is placed, of the projectors 10. Specifically, the image correction unit 108 allocates the split image A′ to the projector 10a “PJ001”, allocates the split image B′ to the projector 10b “PJ002”, and allocates the split image C′ to the projector 10c “PJ003”.

Next, the image correction unit 108 reads out the calibration parameters of the projectors 10, to each of which a corresponding one of the split images is allocated, from the field 504 in the device-information management table 500 and corrects the split images using the read-out calibration parameters. Specifically, the image correction unit 108 corrects the split image A′ using the calibration parameter of the projector 10a, corrects the split image B′ using the calibration parameter of the projector 10b, and corrects the split image C′ using the calibration parameter of the projector 10c.

At this time, the image correction unit 108 determines areas where adjacent two of the projection available areas overlap based on the projection available areas A, B, and C of the projectors 10a, 10b, and 10c, and corrects brightness of the overlapped areas in the split images so as to prevent an undesirable situation that seams between the images are visually detected, which can occur when the overlapped areas are unnaturally brighter than the other areas.

At the next step, S208, the image transmission unit 109 transmits the corrected split images respectively to the corresponding projectors 10. Specifically, the image transmission unit 109 reads out the IP addresses of the projectors 10, to which the split images are allocated, from the field 502 in the device-information management table 500 and transmits the corrected split images to the read-out IP addresses.

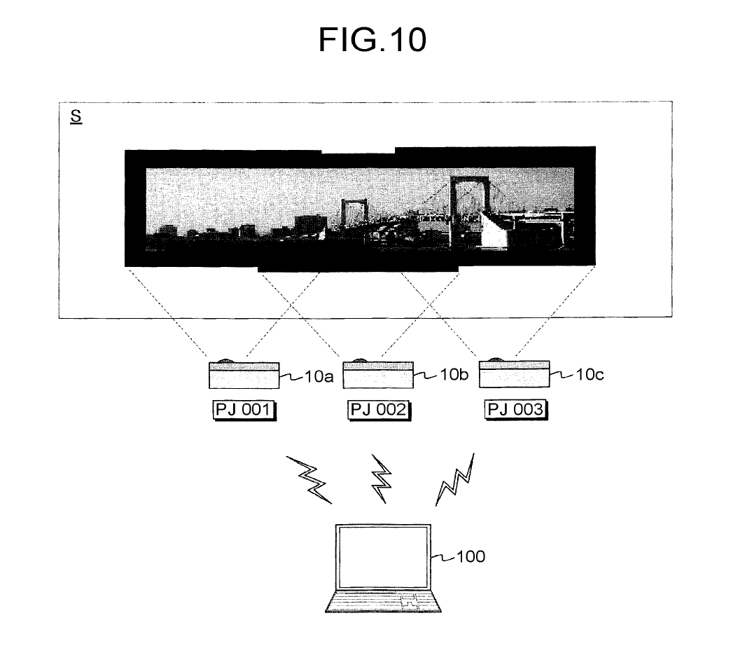

The split image transmitted from the PC 100 is received by the image receiving unit 14 of each of the projectors 10. The image projection unit 16 projects the split image onto the projection surface S. FIG. 10 illustrates a situation where the split images, which are received from the PC 100, are projected by the three projectors (10a, 10b, and 10c) simultaneously. As illustrated in FIG. 10, the images projected by the three projectors (10a, 10b, and 10c) are joined to form a large-screen image of the content image.

As described above, according to the embodiment, because locating projection positions of placed projectors and calculating calibration parameters of the respective projectors can be done based on a single image capture result, a preparatory work for multi-image projection can be facilitated.

While the present invention has been described above with reference to the embodiments, it should be understood that the embodiments are not intended to limit the scope of the present invention, and various design modifications can be made.

For example, in the description given above, a calibration image is generated by embedding, as identification information about the projector 10, the device ID of the projector 10 in a calibration pattern. Alternatively, a calibration image may be generated by embedding the IP address of the projector 10 in the calibration pattern.

The calibration image is not necessarily generated by the projector 10. Alternatively, a scheme of storing a calibration image obtained by embedding identification information in a calibration pattern in the storage area 18 and reading out the calibration image as required may be employed.

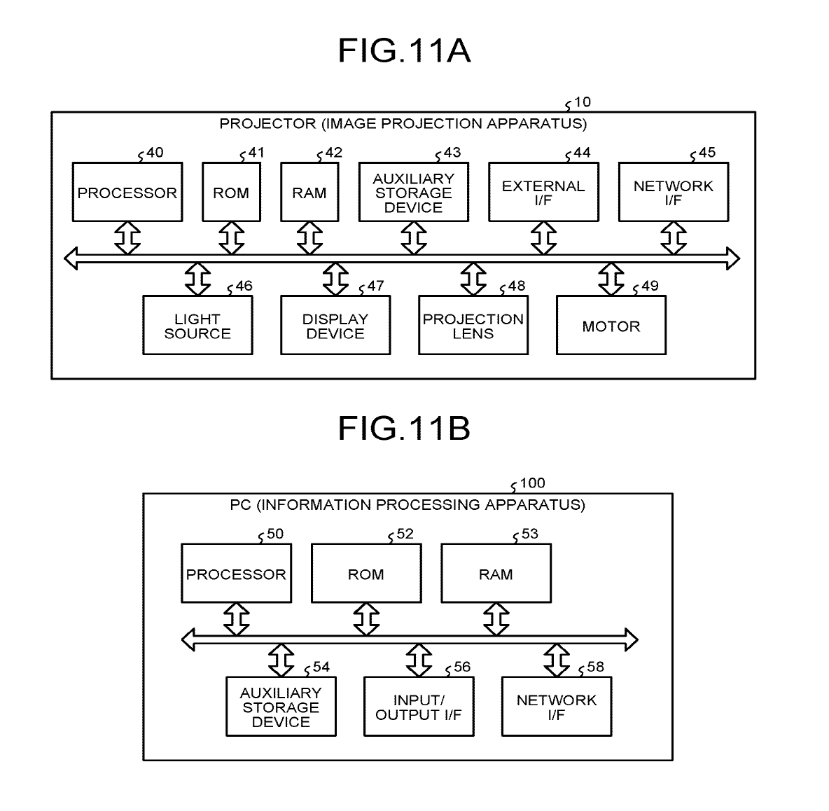

A hardware configuration of the above-described projector 10 (image projection apparatus) and that of the PC 100 (information processing apparatus) are described below with reference to hardware configuration diagrams illustrated in FIGS. 11A and 11B.

As illustrated in FIG. 11A, a controller (computer) of the projector 10 includes at least a processor 40 that controls operations of the entire image projection apparatus, a ROM 41 that stores boot program instructions, firmware program instructions, and the like, a RAM 42 that provides an execution space for executing the program instructions, an auxiliary storage device 43 for storing various types of data, such as the calibration pattern and the identification information about the image projection apparatus, to which the controller belongs, various types of applications, and the like, an external interface 44 for connection with an external device, such as a USB memory, and a network interface 45 for connection to the network 30. The projector 10 further includes a light source 46, a display device 47, a projection lens 48, and a motor 49 that drives the projection lens 48 to thereby perform adjustment, such as zooming and focusing. Light exiting the light source 46 is projected onto the projection surface via the display device 47 and the projection lens 48. The display device 47 may be a device including a DMD (Digital Mirror Device) and a color wheel or, alternatively, may be a device including an LCD (Liquid Crystal Display).

As illustrated in FIG. 11B, the PC 100 includes at least a processor 50 that controls operations of the entire information processing apparatus, a ROM 52 that stores boot program instructions, firmware program instructions, and the like, a RAM 53 that provides an execution space for executing the program instructions, an auxiliary storage device 54 for storing an operating system (OS), various types of applications, and the like, an input/output interface 56 for connection with a keyboard, a display, and the like, and a network interface 58 for connection to the network 30.

The above-described functions of the embodiments can be implemented by computing-executable program instructions described in C, C++, C#, or Java (registered trademark), for example. The program instructions of the embodiments may be distributed in a form of being stored in a computing-readable recording medium, which may be provided as a computer program product, such as a CD-ROM, an MO, a DVD, a flexible disk, an EEPROM, and an EPROM. The instructions can be transmitted over a network in a form available to other apparatuses.

As described above, an aspect of the present invention provides a novel image projection system capable of detecting positions of projectors and calculating calibration parameters of the projectors by performing image capture a single time.

The above-described embodiments are illustrative and do not limit the present invention. Thus, numerous additional modifications and variations are possible in light of the above teachings. For example, at least one element of different illustrative and exemplary embodiments herein may be combined with each other or substituted for each other within the scope of this disclosure and appended claims. Further, features of components of the embodiments, such as the number, the position, and the shape are not limited the embodiments and thus may be preferably set. It is therefore to be understood that within the scope of the appended claims, the disclosure of the present invention may be practiced otherwise than as specifically described herein.

The method steps, processes, or operations described herein are not to be construed as necessarily requiring their performance in the particular order discussed or illustrated, unless specifically identified as an order of performance or clearly identified through the context. It is also to be understood that additional or alternative steps may be employed.

Further, any of the above-described apparatus, devices or units can be implemented as a hardware apparatus, such as a special-purpose circuit or device, or as a hardware/software combination, such as a processor executing a software program.

Further, as described above, any one of the above-described and other methods of the present invention may be embodied in the form of a computer program stored in any kind of storage medium. Examples of storage mediums include, but are not limited to, flexible disk, hard disk, optical discs, magneto-optical discs, magnetic tapes, nonvolatile memory, semiconductor memory, read-only-memory (ROM), etc.

Alternatively, any one of the above-described and other methods of the present invention may be implemented by an application specific integrated circuit (ASIC), a digital signal processor (DSP) or a field programmable gate array (FPGA), prepared by interconnecting an appropriate network of conventional component circuits or by a combination thereof with one or more conventional general purpose microprocessors or signal processors programmed accordingly.

It should be noted that a person skilled in the field of information processing technology may employ the present invention using application specific integrated circuits (ASIC) or an apparatus in which circuit modules are connected.

Further, each of the functions (units) may be implemented by one or more circuits.

It should be noted that, in this specification, the circuit may include a processor programmed by software to execute the corresponding functions and hardware which is designed to execute the corresponding functions such as the ASIC and the circuit module.

What is claimed is:

1. An information processing apparatus comprising:
a captured-image receiver configured to receive a captured image that includes projected images of calibration images projected by a plurality of image projection apparatuses, each calibration image including a calibration pattern in which identification information of a corresponding image projection apparatus is embedded;
a calibration-image extractor configured to extract the calibration images from the captured image;
an identification-information extractor configured to extract the identification information from the extracted calibration images;
a projection-position locator configured to identify the image projection apparatuses having projected the calibration images and locate projection positions of the image projection apparatuses based on the identification information extracted from the calibration images and positions of the calibration images in the captured image;
a calibration-parameter calculator configured to calculate calibration parameters of the respective image projection apparatuses having projected the calibration images, based on the extracted calibration images; and
an image corrector configured to split a content image into a plurality of split images and correct the split images based on the number of the identified image projection apparatuses, the projection positions of the image projection apparatuses, and the calibration parameters of the image projection apparatuses.

2. The information processing apparatus according to claim 1, further comprising an image transmitter configured to transmit each of the corrected split images to a corresponding image projection apparatus.

3. The information processing apparatus according to claim 2, wherein
the identification information is information indicating communication destinations of the image projection apparatuses, and
the image transmitter transmits the corrected split images to the destinations indicated by the identification information.

4. The information processing apparatus according to claim 1, further comprising an image capture device configured to generate the captured image.

5. An image projection system comprising:
a plurality of image projection apparatuses; and
an information processing apparatus,
each of the image projection apparatuses including an image projection unit configured to project a calibration image including a calibration pattern in which identification information of the each of the image projection apparatuses is embedded,
the information processing apparatus including
a captured-image receiver configured to receive a captured image that includes projected images of the calibration images projected by the plurality of image projection apparatuses;
a calibration-image extractor configured to extract the calibration images from the captured image;
an identification-information extractor configured to extract the identification information from the extracted calibration images;
a projection-position locator configured to identify the image projection apparatuses having projected the calibration images and locate projection positions of the image projection apparatuses based on the identification information extracted from the calibration images and positions of the calibration images in the captured image;
a calibration-parameter calculator configured to calculate calibration parameters of the respective image projection apparatuses having projected the calibration images, based on the extracted calibration images; and
an image corrector configured to split a content image into a plurality of split images and correct the split images based on the number of the identified image projection apparatuses, the projection positions of the image projection apparatuses, and the calibration parameters of the image projection apparatuses.

6. The image projection system according to claim 5, wherein each of the image projection apparatuses includes a calibration-image generator configured to generate the calibration image including the calibration pattern in which identification information of the image projection apparatus is embedded.

7. A computer program product for being executed on a computer comprising:
receiving a captured image that includes projected images of calibration images projected by a plurality of image projection apparatuses, each calibration image including a calibration pattern in which identification information of a corresponding image projection apparatus is embedded;
extracting the calibration images from the captured image;
extracting the identification information from the extracted calibration images;
identifying the image projection apparatuses having projected the calibration images and locating projection positions of the image projection apparatuses based on the identification information extracted from the calibration images and positions of the calibration images in the captured image;
calculating calibration parameters of the respective image projection apparatuses having projected the calibration images, based on the extracted calibration images; and
splitting a content image into a plurality of split images and correcting the split images based on the number of the identified image projection apparatuses, the projection positions of the image projection apparatuses, and the calibration parameters of the image projection apparatuses.

8. The computer program product according to claim 7, further comprising transmitting each of the corrected split images to a corresponding image projection apparatus.

9. The computer program product according to claim 8, wherein
the identification information is information indicating communication destinations of the image projection apparatuses, and
the corrected split images are transmitted to the destinations indicated by the identification information.
